(19) United States
(12) Patent Application Publication
(10) Pub. No.: US 2014/0270554 A1
(43) Pub. Date: Sep. 18, 2014

(54) IMAGE ENCODING APPARATUS AND IMAGE DECODING APPARATUS

(71) Applicant: Kabushiki Kaisha Toshiba, Minato-ku (JP)

(72) Inventors: Atsushi MATSUMURA, Yokohama-shi (JP); Shinichiro KOTO, Kokubunji-shi (JP); Tomoya KODAMA, Kawasaki-shi (JP); Takashi WATANABE, Yokohama-shi (JP); Tatsuya TANAKA, Kawasaki-shi (JP)

(73) Assignee: Kabushiki Kaisha Toshiba, Minato-ku (JP)

(21) Appl. No.: 14/167,080

(22) Filed: Jan. 29, 2014

(30) Foreign Application Priority Data
Mar. 15, 2013 (JP) 2013-054350

(51) Int. Cl. G06T 9/00

(52) U.S. Cl. CPC G06T 9/004
USPC 382/233; 382/238

(57) ABSTRACT

According to an embodiment, an image encoding apparatus includes a parameter selector and an output selector. The parameter selector selects a coding parameter controlling the first encoder. The coding parameter makes a first code amount generated by the first encoder smaller than a target code amount if the coding parameter is applied to the first pixel group. The output selector selects the encoding result from the first encoder provided that the first code amount generated by the first encoder when the selected coding parameter is applied to the second pixel group is smaller than the second code amount generated by the second encoder.

### CROSS-REFERENCE TO RELATED APPLICATIONS

This application is based upon and claims the benefit of priority from Japanese Patent Application No. 2013-054350, filed Mar. 15, 2013, the entire contents of which are incorporated herein by reference.

### FIELD

Embodiments relate to encoding and decoding of image data.

### BACKGROUND

Image encoding may use predictive coding (Differential Pulse Code Modulation (DPCM)) based on a pixel adjacent to a pixel to be encoded because the pixels are highly correlated with each other.

Image encoding may involve controlling the generated code amount of input image data to a target code amount or less and storing the resultant image data in a storage such as a predetermined amount of memory or HDD. Control of the code amount is important in image encoding.

For example, a code amount control technique is known which involves applying a plurality of quantization parameters to a residual signal resulting from DPCM of a coding process unit to calculate generated code amounts for the respective quantization parameters and selecting one of the quantization parameters that makes the generated code amount equal to or smaller than a target code amount. The code amount control technique is also known to carry out a fixed length coding scheme in parallel to ensure that the generated code amount is equal to or smaller than the target code amount and to select the fixed length coding scheme if no quantization parameter is present which makes the generated code amount equal to or smaller than the target code amount.

The following are needed to accurately calculate, for a coding process unit, a generated code amount resulting from application of a given quantization parameter: execution of an encoding process up to the last pixel of the coding process unit and a comparative calculation for selecting an optimum quantization parameter after completion of the encoding process. As a result, to allow the terminal pixel of the coding process unit to be used to predict a leading pixel of the next coding process unit, more calculations are carried out than for the other pixels. Hence, application of this code amount control technique to hardware causes a delay at the terminal pixel of the coding process unit to form a critical path, reducing throughput.

### BRIEF DESCRIPTION OF THE DRAWINGS

FIG. 1 is a block diagram illustrating an image encoding apparatus according to a first embodiment;

FIG. 2 is a block diagram showing a modification of FIG. 1;

FIG. 3 is a block diagram illustrating an image decoding apparatus according to a second embodiment;

FIG. 4 is a block diagram showing a modification of FIG. 3;

FIG. 5 is a diagram illustrating the structure of image data;

FIG. 6 is a flowchart illustrating an image encoding process carried out by the image encoding apparatus in FIG. 1;

FIG. 7 is a flowchart illustrating a temporary encoding process;

FIG. 8 is a flowchart illustrating a DPCM encoding process;

FIG. 9 is a flowchart illustrating a plus/minus sign prediction process;

FIG. 10 is a flowchart illustrating a parameter selection process;

FIG. 11 is a flowchart illustrating a PCM encoding process;

FIG. 12 is a flowchart illustrating a fixed length encoding process;

FIG. 13A is a flowchart illustrating a variable length encoding process;

FIG. 13B is a flowchart illustrating the variable length encoding process;

FIG. 14 is a flowchart illustrating an image decoding process carried out by the image decoding apparatus in FIG. 3;

FIG. 15 is a flowchart illustrating a PCM decoding process;

FIG. 16 is a flowchart illustrating a fixed length decoding process;

FIG. 17A is a flowchart illustrating a variable length decoding process;

FIG. 17B is a flowchart illustrating the variable length decoding process; and

FIG. 18 illustrates a general-purpose computer.

### DETAILED DESCRIPTION

Embodiments will be described below with reference to the drawings.

According to an embodiment, an image encoding apparatus encodes each process units into which an input image is divided by a predetermined number of pixels. The apparatus includes a first encoder, a second encoder, a first acquisition unit, a second acquisition unit, a parameter selector and an output selector. The first encoder variable length encodes a first pixel group including a leading pixel of the process unit and a second pixel group including remaining pixels of the process unit. The second encoder encodes the second pixel group so that a code amount generated by the second encoder is smaller than a maximum code amount that can be generated by the first encoder. The parameter selector selects a coding parameter controlling the first encoder. The output selector selects an encoding result to be output. The coding parameter makes a first code amount generated by the first encoder smaller than a target code amount if the coding parameter is applied to the first pixel group. The output selector selects the encoding result from the first encoder provided that the first code amount generated by the first encoder when the selected coding parameter is applied to the second pixel group is smaller than the second code amount generated by the second encoder.

Elements identical or similar to described elements are denoted by identical or similar reference numerals, and duplicate descriptions are basically omitted.

FIG. 5 illustrates image data input to an image encoding apparatus or decoded image data output by an image decoding apparatus. Units used herein correspond to units (hereinafter also referred to as coding process units) processed by the image encoding apparatus or the image decoding apparatus.

According to a first embodiment and a second embodiment, the unit is shaped like a rectangle formed of 1×32 pixels. A segment is shaped like a rectangle formed of one or more units. The segment is indicative of a data unit that is encoded or decoded by a predetermined code amount. According to the first embodiment and the second embodiment, one segment is formed of 1×M units.

Input image data or output image data is shaped like a rectangle formed of one or more segments. According to the first embodiment and the second embodiment, one line of an image corresponds to one segment, and the input image data or output image data is formed of N segments. When the width of an image is indivisible by 32, a unit at the right end comprises 32 pixels or less. For example, processing may be carried out after consecutively copying the terminal image to the right side to obtain 32 pixels to reconfigure the unit at the right end, or processing may be continued with the unit treated as a normal unit and terminated when no more pixels are available. This operation will be described below.

The shapes of the unit and segment according to the first embodiment and the second embodiment are not limited to the above-described shapes. Furthermore, in the description below of the first embodiment and the second embodiment, the image size of input image data is 1,920×1,080 pixels, the image format of input image data is YUV444, and each YUV component comprises 8 bits. However, the image size and image format according to the first embodiment and the second embodiment are not limited to the above-described example.

### First Embodiment

The image encoding apparatus according to the first embodiment carries out a process of selecting from coding parameters (for example, a quantization parameter and a variable length table) in the middle of a unit to be encoded. Hence, the image encoding apparatus prevents the parameter selection process from causing a delay at the terminal of the unit, enabling an image encoding process with high throughput.

FIG. 1 illustrates the image encoding apparatus. The image encoding apparatus comprises an input image selector 102, a first encoder 103, a second encoder 104, a third encoder 105, a first code amount acquisition unit 106, a second code amount acquisition unit 109, a coding parameter selector 107, and an encoded output selector 108.

The input image selector 102 acquires one unit of image data from input image data 101, and outputs the image data to the first encoder 103, the second encoder 104, or the third encoder 105. Moreover, the input image selector 102 carries out an initialization process and a code amount control process described below.

The first encoder 103 encodes input image data in accordance with a variable length encoding process based on a predetermined coding parameter. The second encoder 104 encodes input image data in accordance with a fixed length encoding scheme. The third encoder 105 encodes the input image data in accordance with a PCM encoding scheme of directly outputting the input image data without processing.

The first code amount acquisition unit 106 acquires, accumulates, and holds a first code amount resulting from encoding carried out by the first encoder 103. The second code amount acquisition unit 109 acquires, accumulates, and holds a second code amount resulting from encoding carried out by the second encoder 104.

The coding parameter selector 107 selects a coding parameter that meets a predetermined condition, based on a plurality of first code amounts resulting from encoding carried out by the first encoder 103 using a plurality of coding parameters. The encoded output selector 108 outputs an encoding result (which corresponds to encoded data 110) from one of the first encoder 103, the second encoder 104, and the third encoder 105 based on the first code amount, the second code amount, and an output result from the third encoder 105.

FIG. 6 illustrates an image encoding process carried out by the image encoding apparatus according to the first embodiment.

The input image selector 102 can change a process to be executed on an input unit depending on a position in the image data in the unit. When the unit lies at the head of the image data, the input image selector 102 carries out an initialization process such as resetting of an accumulated value for control of a generated code amount (S102). When the unit lies at the head of a segment, the input image selector 102 sets a target code amount for the segment (S103), and calculates an average value of quantization parameters (QP) for a segment preceding the current segment (S104). The QP controls image quality and the generated code amount.

Moreover, when the unit lies at the terminal of the segment and the number of pixels in the unit is smaller than a predetermined value (X), the input image selector 102 outputs image data to the third encoder 105. When the number of pixels in the unit is larger than the predetermined value (X), the input image selector 102 outputs the image data to the first encoder 103.

The first encoder 103 calculates a target code amount for encoding the image data in the input unit (S106). Then, the first encoder 103 carries out a temporary encoding process for selecting the optimum coding parameter (S107).

The encoded output selector 108 selectively determines whether to carry out variable length encoding or fixed length encoding on the image data in the input unit based on the result of the temporary encoding, and notifies the input image selector 102 of the selected encoding (S108).

The first encoder 103 carries out a variable length encoding process (S109). The second encoder 104 carries out a fixed length encoding process (S110). The third encoder 105 carries out a PCM encoding process (S111). The encoded output selector 108 outputs a final encoding result for the unit as encoded data 110 (S112). An encoding process on the unit is repeated, and encoded data of the segment is output (S113). The image encoding process thus ends (S114).

The process steps in FIG. 6 will be described below in detail.

In step S103, the target code amount for the segment is set in accordance with a user's specification. For example, when ½ compression is specified, the target code amount is set to be 1,920 pixels×3 components×8 bits/2=23,040 bits, and the generated code amount of the segment is invariably controlled to be equal to or smaller than the set target code amount.

In step S104, the average QP of the preceding segment can be calculated by holding QPs applied to the units of the preceding segment, accumulatively adding the QPs together, and dividing the result of the addition by the number of the units in the segment.

In step S106, the target code amount for the unit is, for example, an average value resulting from division of a code amount assigned to the segment by the number of the units. However, feeding back the difference between a code amount resulting from the preceding unit and the target code amount enables a more suitable target code amount to be calculated.

FIG. 7 illustrates the temporary encoding process carried out in step S107.

The temporary encoding is carried on all combinations of quantization parameters and variable length tables described below, in parallel. When the temporary encoding is carried out, first code amounts are calculated, the number of which depends on the number of the combinations of the quantization parameters and the variable length tables.

The first encoder 103 inputs a first pixel group (S202). The first pixel group refers to a predetermined number of pixels starting at the head of the unit. The number of pixels in the first pixel group is determined according to a duration or the number of cycles needed for the coding parameter selector 107 to carry out a parameter selection process. According to the present embodiment, the number of pixels in the first pixel group is 32−6=26 pixels. The first encoder 103 determines whether a unit including the input first pixel group is the leading unit in the segment (S203). When the result of the determination is YES, the first encoder 103 carries out PCM encoding on the leading pixel, and a processing target shifts to the next pixel (S204). In step S203, when the result of the determination is NO, the processing proceeds to an encoding process loop for the first pixel group.

According to the present embodiment, the first encoder 103 utilizes a DPCM encoding process of predicting a pixel to be encoded from an adjacent pixel, quantizing a prediction residual in accordance with the quantization parameter, and carrying out a variable length encoding on the resultant information. That is, the first encoder 103 carries out a DPCM encoding process on the first pixel group (S205).

FIG. 8 illustrates a DPCM encoding process.

The first encoder 103 first carries out a clipping process on an upper limit value and a lower limit value for an input pixel (S302). The clipping process is carried out in accordance with the value of the quantization parameter. For example, when the QP is 0, clipping of a pixel value is omitted. When the QP is 1, the pixel value is clipped between 1 and (255−1). When the QP is 2, the pixel value is clipped between 2 and (255−2). When the QP is 3, the pixel value is clipped between 4 and (255−4). That is, the pixel value is clipped at the value of a quantization error resulting from quantization with the value of the QP. In the present example, the range of the pixel value for encoding of 8-bit data is from 0 to 255. However, for 10 bits, the range of the pixel value is from 0 to 1,023. Each of the QPs applied in the clipping process has a value set to allow temporary encoding to be carried out in parallel.

The first encoder 103 calculates the difference between a clipped pixel and an adjacent pixel (S303). The present embodiment uses one-dimensional DPCM that calculates the difference between the clipped pixel and the left adjacent pixel.

The first encoder 103 quantizes the difference in order to control the image quality and the code amount (S304). Various quantization techniques are known. According to the present embodiment, the first encoder 103 carries out quantization by dividing the pixel value by the QPth power of 2. However, the quantization technique according to the present embodiment is not limited to this. Free design is possible; QP=0 corresponds to omission of quantization, QP=1 corresponds to ⅓, and QP=2 corresponds to 1/7.

Quantized data generated in step S304 is used to calculate a code amount. Moreover, the first encoder 103 de-quantizes the quantized data generated in step S304 so that the de-quantized data can be utilized to generate a reference pixel used to predict the next pixel (S305). The first encoder 103 adds the adjacent pixel and the de-quantized data together to generate a reference pixel (S306). Thus, the DPCM encoding process ends (S307).

As shown in FIG. 7, the first encoder 103 carries out a plus/minus sign prediction process after the DPCM encoding process (S206). FIG. 9 illustrates the plus/minus sign prediction process. The plus/minus sign prediction process starts using the quantized data obtained by the DPCM encoding process as an input (S401).

The first encoder 103 determines whether two pieces of quantized data immediately before the current quantized data have a minus sign (however, quantized data of 0 is also considered to be negative) and the value for the current quantized data is different from the minimum value (S402). If the result of the determination in step S402 is YES, the first encoder 103 inverts the sign of the current quantized data (S403). If the result of the determination in step S402 is NO, the first encoder 103 continues the processing. Thus, the plus/minus sign prediction process ends (S405).

As shown in FIG. 7, the first encoder 103 carries out a process of accumulating generated code amounts after the plus/minus sign prediction process (S207). The generated code amount is calculated by applying a variable length coding table to the quantized data. The present embodiment prepares a plurality of parameters (K) that control the suffix length of exponential Golomb coding. For K=0, the suffix is 1b when the quantized data is 0, 01b when the quantized data is 1, 001b when the quantized data is −1, 0001b when the quantized data is 2, . . . . For K=1, the suffix is 10b when the quantized data is 0, 11b when the quantized data is 1, 010b when the quantized data is −1, 011b when the quantized data is 2, . . . . That is, the code amount decreases consistently with the value of K if the value of the quantized data mainly resides in the vicinity of 0. On the other hand, the code amount decreases consistently with increasing value of K if the value of the quantized data disperses. The variable length tables applied to calculate the generated code amounts are set to allow the temporary encoding to be carried out in parallel.

When the processing of the first pixel group ends, the process flow is divided into two. One of the resultant flows processes the second pixel group, the remaining pixels in the unit, and the other flow carries out a parameter selection process.

The processing of the second pixel group (S208 to S212) is the same as that of the processing of the first pixel group except for the number of pixels, and will thus not be described below.

The temporary encoding is carried out in parallel based on a plurality of QPs and a plurality of variable length tables. Then, the parameter selection process is carried out in accordance with the generated code amounts of the first pixel group for the combinations of the respective parameters (S213).

In step S214, a code amount resulting from the second pixel group is compared with a value estimated as the code amount of the second pixel group in the parameter selection process (the value will be described below in detail). If the generated code amount of the second pixel group is smaller than the estimated value, the encoding scheme for the second pixel group is determined to be DPCM encoding. If the generated code amount of the second pixel group is larger than the estimated value, the encoding scheme for the second pixel group is determined to be an encoding scheme different from DPCM encoding (according to the present embodiment, fixed length encoding) (S214). Thus, the temporary encoding process ends (S215).

FIG. 10 illustrates a parameter selection process.

First, one of the variable length tables is searched for which results in the smallest code amount when the variable length tables are applied to the quantized data quantized using the respective QPs (S502). Thus, generated code amounts based on the respective QPs are determined.

Then, one of the QPs is searched for which is indicative of a generated code amount smaller than a target code amount set for each unit (S503). However, at the point in time of step S503, the accumulated value of the code amount of only the first pixel group has been calculated. Thus, the code amount of the remaining, second pixel group needs to be estimated and added to the accumulated value. The present embodiment can ensure that the maximum value of the code amount of the second pixel group is equal to or smaller than a generated code amount resulting from the application, to the second pixel group, of fixed length encoding similar to the fixed length encoding carried out by the second encoder 104. Thus, when a QP resulting in a generated code amount smaller than the target code amount is searched for, a reference is a code amount resulting from the addition of the code amount of the first pixel group calculated using each QP and the code amount resulting from the application of fixed length encoding to the second pixel group. The fixed length encoding scheme used may be the same as or different from the fixed length encoding scheme carried out by the second encoder 104. When, as a result of a search for a QP, the QP resulting in a code amount smaller than the target code amount has a value larger than the maximum value that can be set, a scheme other than the variable length encoding scheme is adopted. The parameters are output as, for example, N/A.

Then, the apparatus checks whether the QP for a segment (that is, according to the present embodiment, a segment positioned above the segment to be processed) before the segment to be processed tends to increase in the right of the position of the current unit (S504). If the QP tends to increase, pre-increasing the QP makes code amount control and image quality more stable (S505). Whether the QP tends to increase may be determined based on whether the QP is, for example, +2 or +1 with respect to the average QP for the segment. It is expected that, if a QP with an average of +2 or more is applied to a unit positioned in the right of the preceding segment, the QP is increased by 2 and that if a QP with an average of +1 or more is applied to the unit positioned in the right of the preceding segment, the QP is increased by 1.

The finally determined QP is used to generate a reference pixel for a pixel at the terminal of the unit (S506). A technique for generating a reference pixel has been described in connection with the DPCM encoding process and is thus omitted. The QP to be utilized for the next segment is stored (S507), and the parameter selection process ends (S508).

FIG. 13A and FIG. 13B illustrate the variable length encoding process carried out in step S109 in FIG. 6. First, information indicating that variable length coding is applied and information indicative of the selected QP and variable length table are encoded to obtain a variable length coding header (S802). Many portions of the subsequent processing are the same as the corresponding portions of the temporary encoding process, and thus, only the differences between the variable length encoding process and the temporary encoding process will be described.

After the encoding of the first pixel group ends, the process shifts to the encoding of the second pixel group. It is determined that whether the encoding scheme for the second pixel group determined during the temporary encoding is the DPCM encoding as is the case with the first pixel group (S810). If the encoding scheme for the second pixel group is the DPCM encoding, an encoding process similar to that (variable length encoding process) carried out during the temporary encoding is carried out, and the processing ends (S818). At this time, information indicative of the encoding scheme for the second pixel group is also encoded. The information may be encoded in the header or at the head of the second pixel group.

If the encoding scheme for the second pixel group is not the DPCM encoding, it is determined that whether the pixel to be processed is the terminal pixel in the unit (S814).

In step S814, if the result of the determination is YES, a reference pixel resulting from DPCM encoding of the terminal pixel is PCM encoded (S817). Thus, even when the encoding scheme for the second pixel group is different from the encoding scheme for the first pixel group, the reference pixel used to predict a leading pixel in the next unit is the same as the reference pixel generated during the temporary encoding. Consequently, the next unit can be temporarily encoded without a delay, allowing high throughput to be achieved.

In step S814, if the result of the determination is NO, the input pixel value is quantized into C bits (S815). According to the present embodiment, the bit width (8 bits) of the input pixel minus the value of the QP is represented by C, and the input pixel value is quantized by division by the QPth power of 2. The quantized data is encoded into a fixed length of C bits (S816). Thus, the variable length encoding process ends.

FIG. 12 illustrates the fixed length encoding process carried out in step S110 in FIG. 6.

First, a fixed length of A bits and a fixed length of B bits are calculated from the target code amount (S702). For example, when the target code amount is 100, the target code amount is indivisible by 32 pixels. Thus, A and B are set to 4 and 3, respectively, and the apparatus controls the number of pixels to which the A bits are applied and the number of pixels to which the B bits are applied. Consequently, the generated code amount can be controlled to the target code amount or smaller. Then, information indicative of the application of the fixed length encoding is encoded (S703).

Then, fixed length encoding is carried out using A bits. The number of pixels to which the A bits are applied can be determined so that 4×Y+3×(32−Y)=100. In the present example, Y=4. The subsequent processing is similar to the fixed length encoding applied to the second pixel group during the temporary encoding and will thus not be described in detail. It should be noted that, for the processing in FIG. 12, for example, an additional process of removing an LSB side so as to obtain a target bit width is assumed in connection with the quantization technique.

Fixed length encoding for A bits is carried out on Y pixels, and fixed length encoding for B bits is carried out on 32−Y pixels. Thus, the fixed length encoding process ends (S708).

FIG. 11 illustrates the PCM encoding process carried out in step S111 in FIG. 6.

First, information indicating that the PCM coding is to be applied is encoded (S602). Then, the input pixel value is encoded based on an input bit width (S603). Thus, the PCM encoding process ends (S604).

In the present embodiment, the processing on one component has been described. However, the above-described processing is carried out on each component. That is, for YUV444, the above-described processing is carried out on each of three components. For example, the accumulated value of the code amount is managed for each of the three components. For YUV422, when it is assumed that U lies at the position of each even-numbered pixel of Y and that V lies at the position of each odd-numbered pixel of Y, U and V can be processed as one component.

Furthermore, the present embodiment allows the value of the QP to be controlled differently between Y and U/V. For example, Y may allow the QP to be controlled to 0, 1, 2, 3, . . . . U/V may allow the QP to be controlled to 2, 4, 6, . . . . Then, for QP=1, Y is controllably quantized using QP=1, and U/V is controllably quantized using QP=2. This enables the image quality to be controlled with emphasis placed on Y.

As a modification of the present embodiment, the case in FIG. 2 may be modified such that the final unit is also encoded as usual and in which no encoder for the PCM encoding, which is a special mode, is provided. Thus, in hardware implementation, a reduction in the scale of a circuit is possible.

The above-described embodiment selects the appropriate quantization parameter at the end of the temporary encoding of the coding process unit. This prevents a possible delay in the process of predicting the leading pixel of the next coding process unit, enabling image encoding with high throughput to be achieved.

### Second Embodiment

An image decoding apparatus according to a second embodiment can decode encoded data generated by the image encoding apparatus according to the first embodiment by switching a decoding scheme in the middle of a unit to be decoded.

FIG. 3 illustrates the image decoding apparatus. The image decoding apparatus includes a decoding switch unit 402, a first decoder 403, a second decoder 404, and a third decoder 405. The decoding switch unit 402 receives and analyzes encoded data, selects one of the first decoder 403, the second decoder 404, and the third decoder 405, and outputs the encoded data to each of the decoders. The first decoder 403 decodes the encoded data based on a variable length decoding process in accordance with a DPCM decoding process to generate a decoded image. The second decoder 404 decodes the encoded data based on a fixed length decoding process to generate a decoded image. The third decoder 405 decodes the encoded data based on a PCM decoding process to generate a decoded image.

FIG. 14 illustrates an image decoding process carried out by the image decoding apparatus according to the second embodiment.

The decoding switch unit 402 carries out an initialization process of resetting an accumulated code amount or the like in accordance with the position of a decoded image being decoded (S902). The decoding switch unit 402 also analyzes header information in input encoded data (S903) and determines to which of the first decoder 403, the second decoder 404, and the third decoder 405 the encoded data is to be output (S904 and S905).

The first decoder 403 carries out a variable length decoding process (S906). The second decoder 404 carries out a fixed length decoding process (S907). The third decoder 405 carries out a PCM decoding process (S908).

A decoded image for each unit is output which results from decoding carried out by one of the decoders (S909). All units in a segment are decoded (S910), and decoding of all segments in an image is finished to end an image decoding process (S911).

FIG. 17A and FIG. 17B illustrate the variable length decoding process carried out in step S906 in FIG. 14.

First, it is determined that whether a position in the image where decoding is being carried out corresponds to the leading unit in the segment (S1202). If the result of the determination in step S1202 is YES, data corresponding to the bit width (8 bits) of an input pixel is loaded (S1203). The loaded data is output as decoded pixels (S1204), and the processing shifts to the next pixel.

Then, the first pixel group is processed. The information on the QP and variable length table selected during encoding has been acquired during analysis of the header. Then, the data is decoded using a selected variable length table (S1205). Decoded values are set to be quantized data (S1206). The plus/minus sign prediction process is carried out using the quantized data as an input (S1207). This process is similar to that according to the first embodiment and will thus not be described in detail.

The quantized data is de-quantized using the selected QP (S1208). In this case, de-quantization can be more efficiently achieved when a scheme for the de-quantization corresponds to the scheme for de-quantization used during encoding on a one-to-one basis. Hence, the present embodiment utilizes the same de-quantization scheme as that used to generate a reference pixel in the first embodiment.

According to the present embodiment, to decode data encoded by the DPCM encoding scheme based on a prediction from an adjacent pixel, the first decoder 403 adds the de-quantized data to a pixel to the left of the current pixel and outputs the resultant decoded pixel (S1209).

Then, the second pixel group is processed. A start point in the second pixel group may be determined by the user's specification or dynamically switched. The present embodiment assumes that the data encoded according to the first embodiment is decoded, and thus, the start point in the second pixel group is the remaining 6 pixels in the unit determined by the user's specification. However, for example, the variable length table may dynamically switch the start point in the second pixel group utilizing an escape code. That is, no escape code may be generated during the processing of the first pixel group but an escape code may be generated when the first pixel group is switched to the second pixel group.

It is determined that whether variable length encoding has been applied to encoded data for the second pixel group (S1210). A technique for the determination may involve, for example, embedding 1-bit switching information in the encoded data so that the 1-bit switching information can be analyzed for the determination.

If variable length encoding has been applied to the second pixel group, processing applied to the second pixel group is similar to the processing applied to the first pixel group and will thus not be described in detail. If variable length encoding has not been applied to the second pixel group, it is determined that whether the pixel to be decoded lies at the terminal of the unit (S1216).

If the result of the determination in step S1216 is YES, data corresponding to the bit width (8 bits) of the input pixel is loaded in order to decode PCM encoded data (S1217). The loaded data is output as a decoded pixel (S1218).

If the result of the determination in step S1216 is NO, data corresponding to C bits is loaded in order to decode fixed-length-encoded data (S1219). The width of the C bits can be calculated from a QP selected and the bit width (8 bits) of the input pixel as in the case of the first embodiment.

The loaded data is de-quantized according to the pixel bit width (S1220). The image quality is improved by adapting the de-quantization scheme corresponding to the quantization scheme carried out in the first embodiment. If the LSB side has been removed, the de-quantization can be carried out by embedding 0s in the LSB side. The de-quantized data is output as a decoded pixel (S1221). Thus, the variable length decoding process ends (S1223).

FIG. 16 illustrates the fixed length decoding process carried out in step S907 in FIG. 14.

First, fixed-length A bits and fixed-length B bits are calculated from the target code amount (S1102). This processing is similar to (S702) in the first embodiment. Thus, detailed descriptions are omitted, and A, B, and Y are set to 4, 3, and 4, respectively, as is the case with the first embodiment.

First, in a loop of Y pixels, 4-bit data is loaded (S1103).

To allow the loaded data to be de-quantized into 8 bits, for example, 0s are embedded in the LSB side (S1104). Alternatively, based on a lower 1 bit of the loaded 4-bit data, the highest bit (in this case, the fourth bit) of the 0s embedded in the LSB side may be controllably set to 1 instead of 0. De-quantized data is output as a decoded pixel (S1105).

For a subsequent loop of 32−Y pixels, the contents of processing are the same as those described above except for the bit width, and thus, a detailed description thereof is omitted. Then, the fixed length decoding process ends (S1110).

FIG. 15 illustrates the PCM decoding process carried out in step S908 in FIG. 14.

Data corresponding to the bid width (8 bits) of the input pixel is loaded (S1003). The loaded data is output as a decoded pixel (S1004). When decoding of all the pixels in the unit is finished, the PCM decoding process ends. The unit size may not be 32 pixels, but the number of pixels up to the terminal pixel can be acquired when, for example, the user has specified an image width or header information such as image size is present at the head of the decoded data. Then, the PCM decoding process ends (S1005).

As modifications of the present embodiment, the following are possible: a case where a reduction on the scale of a circuit or the like is achieved by omitting the decoder for the PCM decoding process as shown in FIG. 4, and a case where a first code amount acquisition unit 505 acquiring the amount of code decoded by the first decoder 503 is provided so as to allow switching of the decoding scheme for the second pixel group without coding information based on the difference between a first code amount and a value consistent with the calculation of the target code amount for the unit described in the first embodiment.

The above-described image encoding apparatus and image decoding apparatus can be implemented, for example, using a general-purpose computer apparatus as basic hardware. For example, a general-purpose computer shown in FIG. 18 may be used. At least one element shown in FIG. 18 may be implemented using a circuit.

The general purpose computer shown in FIG. 18 includes a control unit 1, a main storage unit 2, an auxiliary storage unit 3, a communication interface (I/F) 4, display unit 5, an operation unit 6 and a bus. The control unit 1 controls the whole computer. The main storage unit 2 may include a read only memory (ROM) or random access memory (RAM) for storing data and a program. The auxiliary storage unit 3 may include hard disk drive (HDD) for storing data and a program. The communication I/F 4 controls communication with an external device. The display unit 5 displays image. The operation unit 6 functions as a user interface. The control unit 1, main storage unit 2, auxiliary storage unit 3 and communication I/F 4, display unit 5 and operation unit 6 are connected via the bus for exchanging data.

Specifically, a processor mounted in the computer apparatus can be made to execute relevant programs to implement the input image selector, the first encoder, the second encoder, the third encoder, the first code amount acquisition unit, the coding parameter selector, encoded output selector, the second code amount acquisition unit, the decoding switch unit, the first decoder, the second decoder, and the third decoder. In this case, the image encoding apparatus may be implemented by pre-installing the programs in the computer apparatus or storing the programs in a storage medium such as a CD-ROM or distributing the programs via a network so that the programs can be appropriately installed in the computer apparatus.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An image encoding apparatus which encodes each process unit into which an input image is divided by a predetermined number of pixels, the apparatus comprising:
a first encoder configured to variable length encode a first pixel group including a leading pixel of the process unit and a second pixel group including remaining pixels of the process unit;
a second encoder configured to encode the second pixel group so that a code amount generated by the second encoder is smaller than a maximum code amount that can be generated by the first encoder;
a parameter selector configured to select a coding parameter controlling the first encoder, wherein the selected coding parameter makes an first code amount generated by the first encoder smaller than a target code amount if the coding parameter is applied to the first pixel group; and
an output selector configured to select an encoding result to be output,
wherein the output selector selects the encoding result from the first encoder provided that the first code amount generated by the first encoder when the selected coding parameter is applied to the second pixel group is smaller than the second code amount generated by the second encoder.

2. The apparatus according to claim 1, wherein the second encoder fixed length encodes the second pixel group so that a code amount generated by the second encoder is smaller than the maximum code amount that can be generated by the first encoder.

3. The apparatus according to claim 1, wherein the target code amount results from subtraction of the second code amount from a code amount assigned to the process unit.

4. The apparatus according to claim 1, wherein the first encoder predictively encodes a pixel to be encoded based on a pixel adjacent to the pixel to be encoded.

5. The apparatus according to claim 1, wherein the output selector outputs flag information indicative of whether to output the encoding result from the first encoder or the encoding result from the second encoder before outputting an encoding result for the second pixel group.

6. The apparatus according to claim 4, wherein, for a pixel adjacent to a process unit next to a current process unit, a first reference pixel based on the encoding result from the first encoder coincides with a second reference pixel based on the encoding result from the second encoder.

7. An image decoding apparatus which decodes each process unit of a predetermined number (N) of pixels, the apparatus comprising:
a first decoder configured to decode encoded data in accordance with a variable length decoding scheme;
a second decoder configured to decode the encoded data so that a code amount generated by the second encoder is smaller than a maximum amount of code that can be decoded in accordance with the variable length decoding scheme; and
a decoding switch unit configured to determine, in a switchable manner, a destination of the encoded data,
wherein the decoding switch unit inputs the encoded data to the first decoder until decoding of a first pixel group (M) including a leading pixel of a process unit is finished, decodes information indicative of a destination of remaining encoded data, and determines, in a switchable manner, the destination of the remaining encoded data.

8. The apparatus according to claim 7, wherein the second decoder fixed length decodes the encoded data.

9. The apparatus according to claim 7, wherein the first decoder predictively decodes a pixel to be decoded based on a pixel adjacent to the pixel to be decoded.

10. An image decoding apparatus which decodes each process unit of a predetermined number (N) of pixels, the apparatus comprising:
a first decoder configured to decode encoded data in accordance with a variable length decoding scheme;
a second decoder configured to decode the encoded data so that a code amount generated by the second encoder is smaller than a maximum amount of code that can be decoded in accordance with the variable length decoding scheme;
a first acquisition unit configured to acquire and accumulate a first code amount processed by the first decoder; and
a decoding switch unit configured to determine, in a switchable manner, a destination of the encoded data,
wherein the decoding switch unit inputs the encoded data to the first decoder until the first code amount accumulated by the first acquisition unit becomes larger than a predetermined threshold and inputs the remaining encoded data to the second decoder when the first code amount becomes larger than the predetermined threshold.

11. The apparatus according to claim 10, wherein the second decoder fixed length decodes the encoded data.

12. The apparatus according to claim 10, wherein the first decoder predictively decodes a pixel to be decoded based on a pixel adjacent to the pixel to be decoded.
